(19) United States
(12) Patent Application Publication
(10) Pub. No.: US 2025/0056630 A1
(43) Pub. Date: Feb. 13, 2025

(54) VEHICLE MOUNTED RELAY USING PROTOCOL DATA UNIT (PDU) SESSION

(71) Applicant: Nokia Technologies Oy, Espoo (FI)

(72) Inventors: Saubhagya BALIARSINGH, Bangalore (IN); Bighnaraj PANIGRAHI, Bangalore (IN)

(21) Appl. No.: 18/791,696

(22) Filed: Aug. 1, 2024

(30) Foreign Application Priority Data
Aug. 11, 2023 (IN) 202341054123

(51) Int. Cl. H04W 76/10; H04W 28/02

(52) U.S. Cl. CPC H04W 76/10; H04W 28/0268

(57) ABSTRACT

A method is disclosed and includes: establishing, by a vehicle-mounted relay user equipment (VMR-UE), a protocol data unit (PDU) session with a core network with which the VMR-UE is subscribed; and transmitting, to the core network, an indication that the PDU session is for at least one of the following: interface control messages of a vehicle-mounted relay network node (VMR-NN) that is mounted with the VMR-UE in a vehicle, user plane (UP) traffic of at least one second UE connected to the VMR-NN, or control plane (CP) traffic of the at least one second UE connected to the VMR-NN.

### CROSS REFERENCE TO RELATED APPLICATIONS

This application claims the benefit of India Provisional Patent Application No. 202341054123, filed Aug. 11, 2023, which is incorporated by reference herein in its entirety.

### FIELD

Various example embodiments relate generally to wireless networks and, more particularly, to extending wireless networks using vehicle mounted relay.

### BACKGROUND

Wireless networking provides significant advantages for user mobility. A user's ability to remain connected while on the move provides advantages not only for the user, but also provides greater efficiency and productivity for society as a whole. As user expectations for connection reliability, processing power, data speed, and device battery life, become more demanding, technology for wireless networking must also keep pace with such expectations. Accordingly, there is continuing interest in improving wireless networking technology.

### SUMMARY

In an aspect of the present disclosure, a method includes: establishing, by a vehicle-mounted relay user equipment (VMR-UE), a protocol data unit (PDU) session with a core network with which the VMR-UE is subscribed; and transmitting, to the core network, an indication that the PDU session is for at least one of the following: interface control messages of a vehicle-mounted relay network node (VMR-NN) that is mounted with the VMR-UE in a vehicle, user plane (UP) traffic of at least one second UE connected to the VMR-NN, or control plane (CP) traffic of the at least one second UE connected to the VMR-NN.

In an aspect of the method, the transmitting the indication may include transmitting the indication that the PDU session is for the interface control messages of the VMR-NN.

In an aspect of the method, the method may further include: receiving, from the VMR-NN, an interface control message; and transmitting, over the PDU session, the interface control message as an application payload of the VMR-UE.

In an aspect of the method, the transmitting the interface control message may include transmitting the interface control message using an identifier parameter of the VMR-NN.

In an aspect of the method, the establishing the PDU session with the core network may include: receiving, from a session management function (SMF) of the core network, an uplink (UL) quality of service (QOS) rule configured for detecting the interface control messages of the VMR-NN.

In an aspect of the method, the method may further include: receiving, by the VMR-UE, an interface control message response from the core network over the PDU session; and transmitting, by the VMR-UE, to the VMR-NN, the interface control message response.

In an aspect of the method, the method may further include: receiving, by the VMR-UE, from the VMR-NN, at least one registration request for the at least one second UE to register with an access and mobility management function (AMF); and transmitting, by the VMR-UE, over the PDU session, the at least one registration request for the at least one second UE.

In an aspect of the method, the method may further include receiving, by the VMR-UE, from the core network over the PDU session, PDU session resource setup information provided by a session management function (SMF), where the PDU session resource setup information is configured to enable the at least one second UE to establish a PDU session with a user plane function (UPF) for the at least one second UE.

In an aspect of the method, the method may further include: receiving, by the VMR-UE, from the VMR-NN, an instruction to establish a second PDU session with the core network for at least one of the UP traffic of the at least one second UE or the CP traffic of the at least one second UE; establishing the second PDU session with the core network, where the second PDU session is distinct from the PDU session for the interface control messages of the VMR-NN; and transmitting, to the core network, an indication that the second PDU session is for at least one of the UP traffic or the CP traffic of the at least one second UE.

In an aspect of the method, the method may further include: receiving, from the VMR-NN, at least one of a UP data of the at least one second UE or a CP data of the at least one second UE; and transmitting, to the core network over the second PDU session, the at least one of the UP data of the at least one second UE or the CP data of the at least one second UE.

In an aspect of the method, the receiving the at least one of the UP data of the at least one second UE or the CP data of the at least one second UE may include receiving a general packet radio service tunneling protocol (GTP)-encapsulated application payload including the at least one of the UP data of the at least one second UE or the CP data of the at least one second UE. The transmitting the at least one of the UP data or the CP data of the at least one second UE may include transmitting, to the core network over the second PDU session, the GTP-encapsulated application payload including the at least one of the UP data or the CP data of the at least one second UE.

In an aspect of the method, the method may further include: receiving, by the VMR-UE, from the core network over the second PDU session, application data for the at least one second UE; and transmitting, to the VMR-NN, the application data for the at least one second UE.

In an aspect of the method, the receiving the application data for the at least one second UE may include receiving a general packet radio service tunneling protocol (GTP)-encapsulated application payload including the application data for the at least one second UE. The transmitting the application data for the at least one second UE may include transmitting the GTP-encapsulated application payload including the application data for the at least one second UE.

In accordance with aspects of the present disclosure, a user equipment includes: at least one processor; and at least one memory storing instructions which, when executed by the at least one processor, cause the user equipment at least to perform a method as in any of the preceding methods.

In accordance with aspects of the present disclosure, a method includes: establishing, by at least one component of a core network, a protocol data unit (PDU) session with a vehicle-mounted relay user equipment (VMR-UE) which is subscribed with the core network; and receiving, from the VMR-UE, an indication that the PDU session is for at least one of the following: interface control messages of a vehicle-mounted relay network node (VMR-NN) that is mounted with the VMR-UE in a vehicle, user plane (UP) traffic of at least one second UE connected to the VMR-NN, or control plane (CP) traffic of the at least one second UE connected to the VMR-NN.

In an aspect of the method, the receiving the indication may include receiving the indication that the PDU session is for the interface control messages of the VMR-NN.

In an aspect of the method, the method may further include: receiving, from the VMR-UE, over the PDU session, an application payload of the VMR-UE, where the application payload of the VMR-UE includes an interface control message of the VMR-NN.

In an aspect of the method, the interface control message of the VMR-NN, received from the VMR-UE, may include an identifier parameter of the VMR-NN.

In an aspect of the method, the method may further include: configuring, by a session management function (SMF) of the at least one component of the core network, an uplink (UL) quality of service (QOS) rule configured for detecting the interface control messages of the VMR-NN; and transmitting, to the VMR-UE, the UL QOS rule for use by the VMR-UE for detecting the interface control messages of the VMR-NN.

In an aspect of the method, the configuring of the UL QOS rule may be based on at least one of the following: an identifier parameter of the VMR-NN, or an identifier parameter of an access and mobility management function (AMF) for the VMR-NN.

In an aspect of the method, the method may further include: obtaining at least one of the following: the identifier parameter of the VMR-NN, or the identifier parameter of the AMF for the VMR-NN, from at least one of the following: a unified data management (UDM) session management (SM) subscription for the VMR-UE, a local configuration of the SMF, or a policy control function (PCF) policy for the VMR-UE.

In an aspect of the method, the method may further include: receiving, from the VMR-UE, during the establishing the PDU session, at least one of the following: the identifier parameter of the VMR-NN, or the identifier parameter of the AMF for the VMR-NN.

In an aspect of the method, the method may further include: configuring a user plane function (UPF), by a session management function (SMF) of the at least one component of the core network, with a packet detection rule (PDR) and forwarding action rule (FAR) configured to detect and forward a packet to the AMF of the VMR-NN, where the packet includes a destination address set to an address of an access and mobility management function (AMF) for the VMR-NN.

In an aspect of the method, the method may further include: configuring a user plane function (UPF), by the session management function (SMF) of the at least one component of the core network, with packet detection rule (PDR) and forwarding action rule (FAR) configured to detect and forward a packet comprising a source address that is set to the address of the AMF of the VMR-NN and that is mapped to a packet forwarding control protocol (PFCP) session.

In an aspect of the method, the method may further include: receiving, by a user plane function (UPF) of the at least one component of the core network, a message from an access and mobility management function (AMF) for the VMR-NN; and generating, based on the message from the AMF for the VMR-NN, a general packet radio service tunneling protocol (GTP)-encapsulated message.

In an aspect of the method, the method may further include: receiving, from the VMR-UE, over the PDU session, at least one registration request for the at least one second UE to register with an access and mobility management function (AMF) for the at least one second UE.

In an aspect of the method, the method may further include: selecting, by the AMF for the at least one second UE, a session management function (SMF) for the at least one second UE.

In an aspect of the method, the method may further include: transmitting, by the SMF for the at least one second UE, over the PDU session, PDU session resource setup information configured to enable the at least one second UE and a user plane function (UPF) for the at least one second UE to establish a PDU session.

In an aspect of the method, the method may further include: establishing a second PDU session with the VMR-UE, where the second PDU session is distinct from the PDU session for the interface control messages of the VMR-NN; and receiving, from the VMR-UE, an indication that the second PDU session is for at least one of the UP traffic of the at least one second UE or the CP traffic of the at least one second UE.

In an aspect of the method, the method may further include: configuring a user plane function (UPF) for the VMR-UE, by a session management function (SMF) for the VMR-UE, with at least one of the following: a packet detection rule (PDR) and forwarding action rule (FAR) configured to detect and forward an uplink packet comprising a destination IP address set to an IP address of a UPF for the at least one second UE, or a PDR and FAR configured to detect and forward a downlink packet comprising a source address set to an address of the UPF for the at least one second UE.

In an aspect of the method, the PDR and FAR are configured to detect and forward the packet to an intermediate data network (DN), where the intermediate DN is a service chaining or forwarding DN configured to forward the packet to the UPF for the at least one second UE.

In an aspect of the method, the method may further include: configuring the UPF for the at least one second UE, by an SMF for the at least one second UE, with at least one of the following: a packet detection rule (PDR) and forwarding action rule (FAR) configured to detect and forward an uplink packet comprising a destination address set to an address of the UPF for the at least one second UE, or a PDR and FAR configured to detect and forward a downlink packet comprising a source address set to an address of an application server.

In an aspect of the method, the method may further include: receiving, by a user plane function (UPF) for the VMR-UE, from the VMR-UE, over the second PDU session, at least one of a UP data or a CP data of the at least one second UE; and forwarding, by the UPF for the VMR-UE, at least one of the UP data of the at least one second UE or the CP data of the at least one second UE.

In an aspect of the method, the forwarding the at least one of the UP data or the CP data of the at least one second UE may include: forwarding the at least one of the UP data or the CP data, by the VMR-UE, to an intermediate data network (DN), where the intermediate DN is a service chaining or forwarding DN configured to forward to the at least one of the UP data of the at least one second UE or the CP data to a UPF for the at least one second UE.

In an aspect of the method, the forwarding the at least one of the UP data of the at least one second UE or the CP data of the at least one second UE may include: forwarding the at least one of the UP data or the CP data, by the UPF for the VMR-UE, to a UPF for the at least one second UE, using IP forwarding over N6 interface.

In an aspect of the method, the UPF for the VMR-UE is also the UPF for the at least one second UE, where the forwarding the at least one of the UP data or the CP data of the at least one second UE includes forwarding the at least one of the UP data or the CP data, by the UPF for the VMR-UE, to a virtual internal port before N6 forwarding.

In an aspect of the method, the method may further include: receiving, by the UPF for the VMR-UE, application data for the at least one second UE; transmitting, to the VMR-UE, over the second PDU session, the application data for the at least one second UE.

In accordance with aspects of the present disclosure, a user equipment includes: at least one processor; and at least one memory storing instructions which, when executed by the at least one processor, cause the user equipment at least to perform a method as in any of the preceding methods.

According to some aspects, there is provided the subject matter of the independent claims. Some further aspects are defined in the dependent claims.

### BRIEF DESCRIPTION OF THE DRAWINGS

Some example embodiments will now be described with reference to the accompanying drawings.

FIG. 1 is a diagram of an example embodiment of wireless networking between a network system and a user equipment apparatus (UE), according to one illustrated aspect of the disclosure;

FIG. 2 is a diagram of example components of a network system, according to one illustrated aspect of the disclosure;

FIG. 3 is a diagram of an example wireless system that includes a vehicle mounted relay, according to one illustrated aspect of the disclosure;

FIG. 4 is a diagram of example interactions of the wireless system of FIG. 3, according to one illustrated aspect of the disclosure;

FIG. 5 is a diagram of example signals and operations of a network system that includes vehicle mounted relay, according to one illustrated aspect of the disclosure;

FIG. 6 is a diagram of another example of signals and operations of a network system that includes vehicle mounted relay, according to one illustrated aspect of the disclosure;

FIG. 7 is a diagram of example interactions of the wireless system of FIG. 3, according to one illustrated aspect of the disclosure; and

FIG. 8 is a diagram of example embodiment of components of a UE or of a network apparatus, according to one illustrated aspect of the present disclosure.

### DETAILED DESCRIPTION

In the following description, certain specific details are set forth in order to provide a thorough understanding of disclosed aspects. However, one skilled in the relevant art will recognize that aspects may be practiced without one or more of these specific details or with other methods, components, materials, etc. In other instances, well-known structures associated with transmitters, receivers, or transceivers have not been shown or described in detail to avoid unnecessarily obscuring descriptions of the aspects.

Reference throughout this specification to “one aspect” or “an aspect” means that a particular feature, structure, or characteristic described in connection with the aspect is included in at least one aspect. Thus, the appearances of the phrases “in one aspect” or “in an aspect” in various places throughout this specification are not necessarily all referring to the same aspect. Furthermore, the particular features, structures, or characteristics may be combined in any suitable manner in one or more aspects.

Embodiments described in the present disclosure may be implemented in wireless networking apparatuses, such as, without limitation, apparatuses utilizing Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, enhanced LTE (eLTE), 5G New Radio (5G NR), 5G Advance, 6G (and beyond) and 802.11ax (Wi-Fi 6), among other wireless networking systems. The term ‘eLTE’ here denotes the LTE evolution that connects to a 5G core. LTE is also known as evolved UMTS terrestrial radio access (EUTRA) or as evolved UMTS terrestrial radio access network (EUTRAN).

The present disclosure may use the term “serving network device” to refer to a network node or network device (or a portion thereof) that services a UE. As used herein, the terms “transmit to,” “receive from,” and “cooperate with,” (and their variations) include communications that may or may not involve communications through one or more intermediate devices or nodes. The term “acquire” (and its variations) includes acquiring in the first instance or reacquiring after the first instance. The term “connection” may mean a physical connection or a logical connection.

As used herein, the term “apparatus” refers to and includes a physical implementation that may include one housing and/or component or may include more than one housing and/or component. In case of more than one housing and/or component, the multiple housings and/or components of an apparatus may be co-located or may be geographically separated.

The present disclosure uses 5G NR as an example of a wireless network and may use smartphones as an example of UEs. It is intended and shall be understood that such examples are merely illustrative, and the present disclosure is applicable to other wireless networks and user equipment apparatuses.

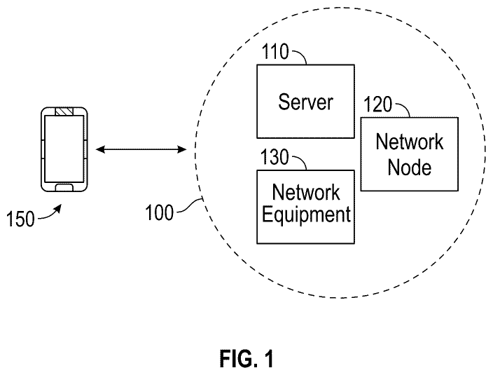

FIG. 1 is a diagram depicting an example of wireless networking between a network system 100 and a user equipment apparatus (UE) 150. The network system 100 may include one or more network nodes 120, one or more servers 110, and/or one or more network equipment 130 (e.g., test equipment). The network nodes 120 will be described in more detail below. As used herein, the term “network apparatus” may refer to any component of the network system 100, such as the server 110, the network node 120, the network equipment 130, any component(s) of the foregoing, and/or any other component(s) of the network system 100. Examples of network apparatuses include, without limitation, apparatuses implementing aspects of 5G NR, among others. The present disclosure describes embodiments related to 5G NR and embodiments that involve aspects defined by 3rd Generation Partnership Project (3GPP). However, it is contemplated that embodiments relating to other wireless networking technologies are encompassed within the scope of the present disclosure.

The following description provides further details of examples of network nodes. In a 5G NR network, a gNodeB (also known as gNB) may include, e.g., a node that provides NR user plane and control plane protocol terminations to the UE and that is connected via a NG interface to the 5G core (5GC), e.g., according to 3GPP TS 38.300 V16.6.0 (2021-06) section 3.2, which is hereby incorporated by reference herein.

A gNB supports various protocol layers, e.g., Layer 1 (L1)—physical layer, Layer 2 (L2), and Layer 3 (L3).

The layer 2 (L2) of NR is split into the following sublayers: Medium Access Control (MAC), Radio Link Control (RLC), Packet Data Convergence Protocol (PDCP) and Service Data Adaptation Protocol (SDAP), where, e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC quality of service (QOS) flows;
Control channels include broadcast control channel (BCCH) and physical control channel (PCCH).

Layer 3 (L3) includes, e.g., radio resource control (RRC), e.g., according to 3GPP TS 38.300 V16.6.0 (2021-06) section 6, which is hereby incorporated by reference herein.

A gNB central unit (gNB-CU) includes, e.g., a logical node hosting, e.g., radio resource control (RRC), service data adaptation protocol (SDAP), and packet data convergence protocol (PDCP) protocols of the gNB or RRC and PDCP protocols of the en-gNB, that controls the operation of one or more gNB distributed units (gNB-DUs). The gNB-CU terminates the F1 interface connected with the gNB-DU. A gNB-CU may also be referred to herein as a CU, a central unit, a centralized unit, or a control unit.

A gNB Distributed Unit (gNB-DU) includes, e.g., a logical node hosting, e.g., radio link control (RLC), media access control (MAC), and physical (PHY) layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU. A gNB-DU may also be referred to herein as DU or a distributed unit.

As used herein, the term “network node” may refer to any of a gNB, a gNB-CU, or a gNB-DU, or any combination of them. A RAN (radio access network) node or network node such as, e.g., a gNB, gNB-CU, or gNB-DU, or parts thereof, may be implemented using, e.g., an apparatus with at least one processor and/or at least one memory with processor-readable instructions (“program”) configured to support and/or provision and/or process CU and/or DU related functionality and/or features, and/or at least one protocol (sub-) layer of a RAN (radio access network), e.g., layer 2 and/or layer 3. Different functional splits between the central and distributed unit are possible. An example of such an apparatus and components will be described in connection with FIG. 12 below.

The gNB-CU and gNB-DU parts may, e.g., be co-located or physically separated. The gNB-DU may even be split further, e.g., into two parts, e.g., one including processing equipment and one including an antenna. A central unit (CU) may also be called baseband unit/radio equipment controller/cloud-RAN/virtual-RAN (BBU/REC/C-RAN/V-RAN), open-RAN (O-RAN), or part thereof. A distributed unit (DU) may also be called remote radio head/remote radio unit/radio equipment/radio unit (RRH/RRU/RE/RU), or part thereof. Hereinafter, in various example embodiments of the present disclosure, a network node, which supports at least one of central unit functionality or a layer 3 protocol of a radio access network, may be, e.g., a gNB-CU. Similarly, a network node, which supports at least one of distributed unit functionality or a layer 2 protocol of the radio access network, may be, e.g., a gNB-DU.

A gNB-CU may support one or multiple gNB-DUs. A gNB-DU may support one or multiple cells and, thus, could support a serving cell for a user equipment apparatus (UE) or support a candidate cell for handover, dual connectivity, and/or carrier aggregation, among other procedures.

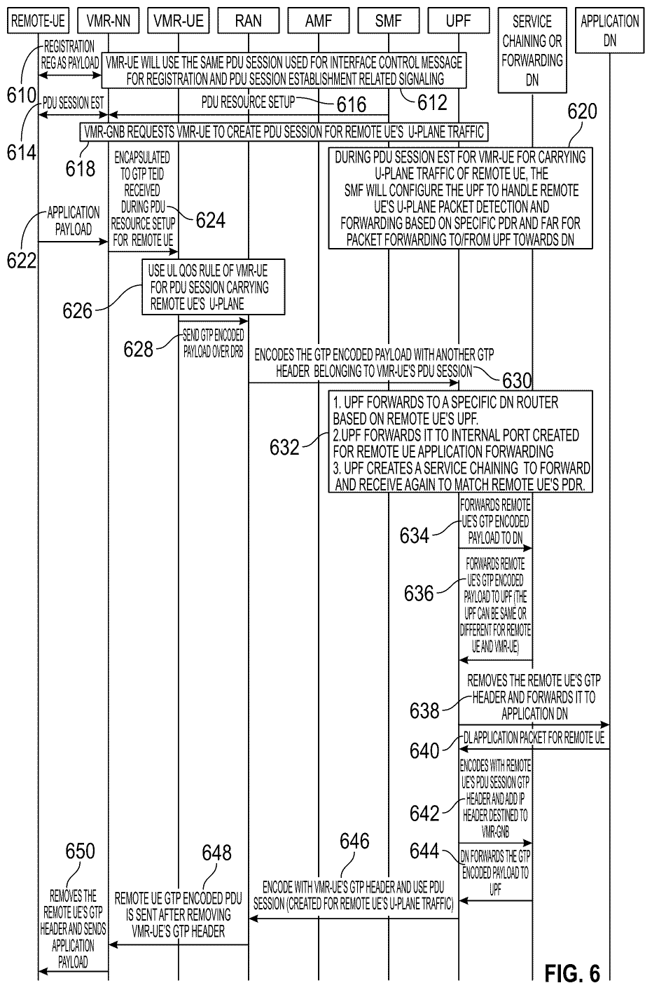

The user equipment apparatus (UE) 150 may be or include a wireless or mobile device, an apparatus with a radio interface to interact with a RAN (radio access network), a smartphone, an in-vehicle apparatus, an IoT device, or a M2M device, among other types of user equipment. Such UE 150 may include: at least one processor; and at least one memory including program code; where the at least one memory and the computer program code are configured to, with the at least one processor, cause the apparatus at least to perform certain operations, such as, e.g., RRC connection to the RAN. An example of components of a UE will be described in connection with FIG. 6. In embodiments, the UE 150 may be configured to generate a message (e.g., including a cell ID) to be transmitted via radio towards a RAN (e.g., to reach and communicate with a serving cell). In embodiments, the UE 150 may generate and transmit and receive RRC messages containing one or more RRC PDUs (protocol data units). Persons skilled in the art will understand RRC protocol as well as other procedures a UE may perform.

With continuing reference to FIG. 1, in the example of a 5G NR network, the network system 100 provides one or more cells, which define a coverage area of the network system 100. As described above, the network system 100 may include a gNB of a 5G NR network or may include any other apparatus configured to control radio communication and manage radio resources within a cell. As used herein, the term “resource” may refer to radio resources, such as a resource block (RB), a physical resource block (PRB), a radio frame, a subframe, a time slot, a sub-band, a frequency region, a sub-carrier, a beam, etc. In embodiments, the network node 120 may be called a base station.

FIG. 1 provides an example and is merely illustrative of a network system 100 and a UE 150. Persons skilled in the art will understand that the network system 100 includes components not illustrated in FIG. 1 and will understand that other user equipment apparatuses may be in communication with the network system 100.

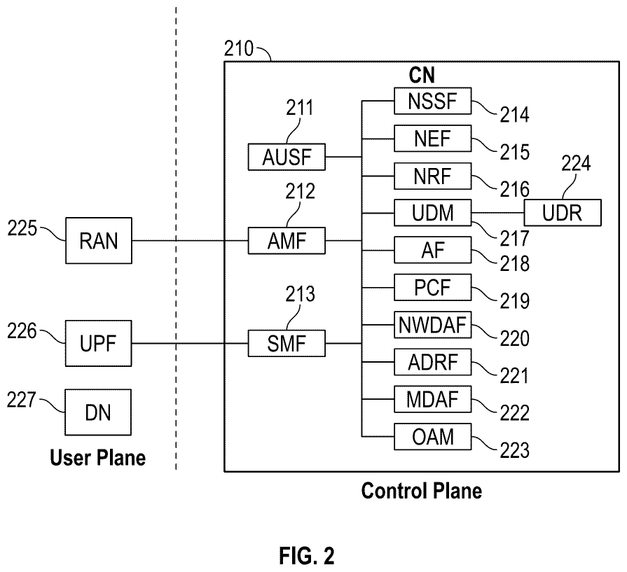

FIG. 2 is a block diagram of example components of the network system 100 of FIG. 1. A 5G NR network may be described as an example of the network system 100, and it is intended that aspects of the following description shall be applicable to other types of network systems, as well. The network system may operate in accordance with the signals and connections shown in FIG. 1 such that the UE 150 is in communication with the network system 100 through the radio access network 225. Additionally, the network system may be divided into user plane components and functions and control plane components and functions, as shown and described herein. Unless indicated otherwise, the terms “component”, “function”, and “service” may be used interchangeably herein, and they may refer to and be implemented by instructions executed by one or more processors.

Example functions of the components are described below. The example functions are merely illustrative, and it shall be understood that additional operations and functions may be performed by the components described herein. Additionally, the connections between components may be virtual connections over service-based interfaces such that any component may communicate with any other component. In this manner, any component may act as a service “producer,” for any other component that is a service “consumer,” to provide services for network functions.

For example, a core network 210 is described in the control plane of the network system. The core network 210 includes an authentication server function (AUSF) 211, an access and mobility function (AMF) 212, and a session management function (SMF) 213. The core network 210 also includes a network slice selection function (NSSF) 214, a network exposure function (NEF) 215, a network repository function (NRF) 216, and a unified data management function (UDM) 217, which may include a uniform data repository (UDR) 224.

Additional components and functions of the core network 210 include an application function (AF) 218, policy control function (PCF) 219, network data analytics function (NWDAF) 220, analytics data repository function (ADRF) 221, management data analytics function (MDAF) 222, and operations and management function (OAM) 223.

The user plane includes the UE 150, a radio access network (RAN) 225, a user plane function (UPF) 226, and a data network (DN) 227. The RAN 225 may include one or more components described in connection with FIG. 1, such as one or more network nodes. However, the RAN 225 may not be limited to such components. The UPF 226 provides connection for data being transmitted over the RAN 225. The DN 226 identifies services from service providers, Internet access, and third party services, for example.

The AMF 212 processes connection and mobility tasks. The AUSF 211 receives authentication requests from the AMF 212 and interacts with UDM 217 to authenticate and validate network responses for determination of successful authentication. The SMF 213 conducts protocol data unit (PDU) session management, as well as manages session context with the UPF 226.

The NSSF 214 may select a network slicing instance (NSI) and determine the allowed network slice selection assistance information (NSSAI). This selection and determination is utilized to set the AMF 212 to provide service to the UE 150. The NEF 215 secures access to network services for third parties to create specialized network services. The NRF 216 acts as a repository to store network functions to allow the functions to register with and discover each other.

The UDM 217 generates authentication vectors for use by the AUSF 211 and ADM 212 and provides user identification handling. The UDM 217 may be connected to the UDR 224 which stores data associated with authentication, applications, or the like. The AF 218 provides application services to a user (e.g., streaming services, etc.). The PCF 219 provides policy control functionality. For example, the PCF 219 may assist in network slicing and mobility management, as well as provide quality of service (QOS) and charging functionality.

The NWDAF 220 collects data (e.g., from the UE 150 and the network system) to perform network analytics and provide insight to functions that utilize the analytics in the providing of services. The ADRF 221 allows the storage, retrieval, and removal of data and analytics by consumers. The MDAF 222 provides additional data analytics services for network functions. The OAM 223 provides provisioning and management processing functions to manage elements in or connected to the network (e.g., UE 150, network nodes, etc.).

FIG. 2 is merely an example of components of a network system, and variations are contemplated to be within the scope of the present disclosure. In embodiments, the network system may include other components not illustrated in FIG. 2. In embodiments, the network system may not include every component illustrated in FIG. 2. In embodiments, the components and connections may be implemented with different connections than those illustrated in FIG. 2. Such and other embodiments are contemplated to be within the scope of the present disclosure.

The following will describe an example of a wireless system having a vehicle mounted relay. In order to extend the coverage of wireless networks, it is proposed to use so-called vehicle mounted relays (VMR). VMR means a kind of base station that will be mounted on a vehicle and that therefore will have, as the backhaul connection, a wireless connection.

In 3GPP Release 18, a study is conducted followed by a work item on VMR. During the study, it was agreed to limit the scope of the work to the IAB (Integrated Access and Backhaul) architecture.

IAB leverages the spectral efficiencies of new radio and the increased capacity afforded by the higher bands available in 5G to deliver an alternative to optical cell site backhaul. This alleviates one of the primary issues surrounding the deployment of 5G that can be employed as a short-term alternative to fiber or as a permanent option for more isolated antennas or those without right of way access. IAB allows for multi-hop backhauling using the same frequencies employed for user equipment (UE) access or a distinct, dedicated, frequency.

Integrated Access and Backhaul specifications define two antenna system types: an IAB node and an IAB donor. IAB donors terminate the backhaul traffic from distributed IAB nodes. These nodes can be backhaul endpoints or relays between those endpoints and the donor. Both IAB donors and nodes serve mobile UEs in the usual way.

IAB requires a decomposed radio access network (RAN) model which decouples distributed unit (DU) from central unit (CU). The DU is present in only the IAB nodes while the donor system also comprises a CU. Defined within standards as including a CU and DU, a single IAB system of one or more IAB nodes and the IAB donor are, together, deemed a single gNB. This approach also ensures the backhaul is insulated within a topologically constrained environment, so routing changes or problems are not propagated into the 5GC or other adjacent gNBs.

However, when using the IAB concept as a VMR basis, there are some limitations to be considered. For example, the approach is not flexible enough, in the sense that the UE in order to become a VMR node, always needs a donor gNB. Furthermore, both mobile IAB and gNB-donor node should have the backhaul adaption protocol (BAP) layer support configured. This could be a limitation for UE vendors/manufacturers. Moreover, an operator must deploy/upgrade all the gNBs in the public land mobile network (PLMN) with donor functionalities to provide seamless VMR functionality, which is not feasible in all deployment scenarios.

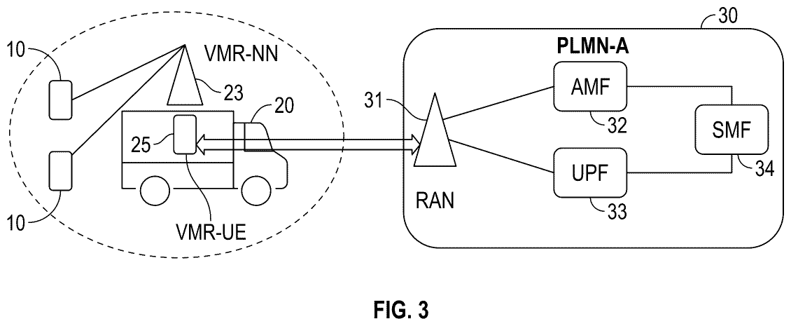

Due to the above-mentioned restrictions, further approaches are considered. One of these approaches is the a so-called “Velcro” system. FIG. 3 shows a diagram illustrating an example for a wireless system that includes a Velcro architecture.

Generally, in a VMR architecture based on Velcro, the relay node includes a UE co-located with a full gNB, with the gNB in the relay establishing N2 and N3 interface to an AMF residing in the core network over a PDU session established to the VMR-UE's PLMN. By means of this approach it is possible to overcome some of the above-mentioned issues such that it does not need a donor gNB and it can reuse existing stack without need of significant changes, etc. That is, the Velcro architecture comprises one full gNB offering connectivity to UEs, where this full (VMR-) gNB is building one entity together with a (VMR-) UE that connects to other “normal” gNBs for the backhaul connection. For

Reference sign 10 denotes one or more UEs which may be referred to as “remote UE(s),” i.e., a UE which connects to the VMR. For convenience, the one or more remote UEs 10 may simply be referred to as UE 10. Any description that refers to UE 10 shall be treated as though the description also refers to one or more UEs 10.

Reference sign 20 denotes the VMR. Reference sign 23 denotes a VMR network node VMR-NN (e.g., gNB) via which the UE 10 can access the PLMN-A. A VMR-UE 25 connects to PLMN-A for backhaul connection for VMR gNB 23.

Reference sign 30 denotes the PLMN-A, i.e., the network of VMR-UE 25. PLMN-A 30 includes, among other elements, a RAN element, such as a network node 31 (e.g., gNB) for connection to the VMR-UE 25, and core network parts, such as an AMF 32 representing a communication network control element or function of the 5GC. The AMF 32 is a control plane function within 5GC and performs, for example, registration management (e.g. allows a UE (e.g., 25) to register/deregister with the 5G system wherein the AMF 32 interacts with other network functions during the registration procedure), connection management (establishing and releasing control plane signaling connection between a UE (e.g., 25) and the AMF 32, NAS messages to be exchanged between the UE (e.g., 25) and the AMF 32, NAS signaling procedures for registration, authentication, service request and identity request), reachability management (by storing location information as part of the UE context, which includes the registration area (a Tracking Area, or a list of Tracking Areas) within which the UE is registered), and mobility management (to maintain knowledge of UE's location within the network, for which the UE makes periodic registration updates after initial registration and updates due to mobility, e.g. if it moves out of the Tracking Area or list of Tracking Areas with which it is currently registered). The AMF 32 is connected to an SMF 34 which is responsible for interacting with the decoupled data plane, creating, updating and removing Protocol Data Unit (PDU) sessions and managing session context with a UPF 33. The UPF denoted by reference sign 33 and is part of control approach to split control and user data. The UPF is responsible for RAN/Data Network interconnection, packet inspection and application detection, packet routing and data forwarding, and QoS management and usage reporting.

As described above, the VMR-UE 25 provides a backhaul connection via PLMN-A 30 by using air interface (see arrow) for VMR-NN 23.

However, in this context, it has to be clarified how a Velcro architecture can be made usable for VMR systems. Specifically, for example, it has to be defined how a VMR-gNB configuration could work (e.g., transmission of non-UE associated data/interface control data to and from the respective wireless networks involved). Furthermore, it is also to be defined how UE-associated data transmission could work (e.g., for UE user plane and/or control plane data).

In order to find solutions for the above points, the following scenario may also be considered where a UE 10 together with the VMR-NN 23 on the one side and the VMR-UE 25 together with the backhaul connection on the other side are not using the same PLMN. That is, the UE 10 is from, e.g., a PLMN B and is communicating with the VMR-NN 23 via this PLMN B. The respective co-located VMR-UE 25, however, which establishes the backhaul connection for the VMR-NN 23 is from a PLMN-A (and connecting to this PLMN-A 30). This situation is a valid and even probable use case because a VMR-NN 23 may offer services for more than one PLMN. Specifically, in VMR scenarios these VMR-NN 23 may be deployed, e.g., as shared gNBs, offering services for PLMN-A, PLMN-B, PLMN-C, etc., so as to be capable to offer services for any UE of any PLMN.

That is, when employing a VMR system with the above described approach, it should be clarified how to establish a connection from the VMR-NN and how to establish a connection from a remote UE that connects to the VMR-NN, when the respective co-located VMR-UE normally connects via conventional PDU sessions to PLMN-A. Also, according to examples of embodiments, a mechanism is proposed which allows to configure and use a VMR based communication where a VMR base station can be shared among multiple communication networks, i.e., multiple operator networks like different PLMNs.

In the following, different examples of embodiments will be described for illustrating a processing for conducting control processes in a wireless network allowing a VMR based communication. To this end, as one example of a wireless network to which examples of embodiments may be applied, a communication network architecture based on 3GPP standards for a communication network, such as 5G NR, is used without restricting the disclosure to such an architecture. It would be apparent to a person skilled in the art that examples of embodiments may also be applied to other kinds of wireless networks, e.g., Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), etc. Furthermore, without loss of generality, the description of some examples of embodiments is related to a mobile communication network, but the principles of described herein can be extended and applied to any other type of network, such as a wired communication network as well.

The general functions and interconnections of the described elements and functions, which also depend on the actual network type, are understood by those skilled in the art and described in corresponding specifications so that a detailed description thereof is omitted herein. However, it is to be noted that several additional network elements and signaling links may be employed for communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet, as well as with individual devices or groups of devices being not considered as a part of a network, such as monitoring devices like cameras, sensors, arrays of sensors, and the like. The communication network may also be able to support the usage of cloud services for virtual network elements or functions thereof, wherein it is to be noted that the virtual network part of the telecommunication network can also be provided by non-cloud resources, e.g., an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

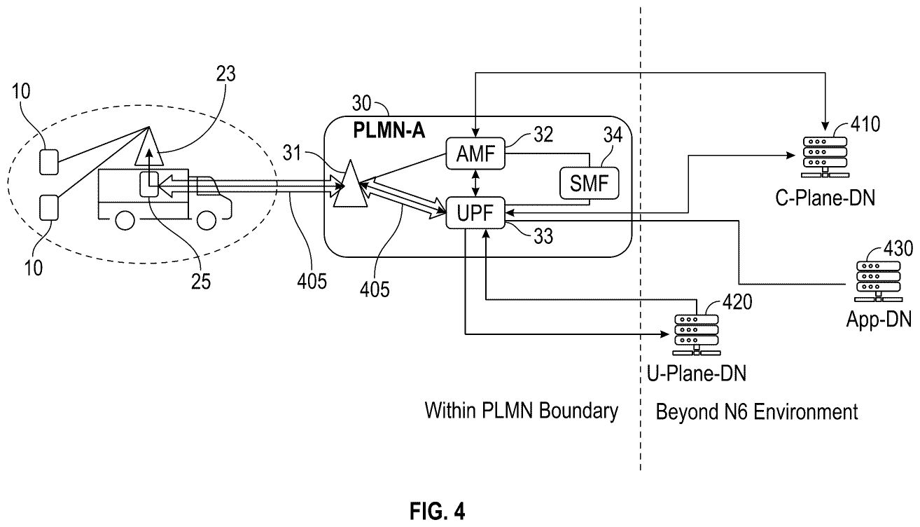

Generally, and referring to FIG. 4, according to examples of embodiments, in a first phase, the VMR-UE 25 creates one or more PDU sessions 405 to its own network (i.e. PLMN-A 30). The VMR-NN 23 and/or the remote UE 10 may then use an application stack of the VMR-UE 10 to access the network over the one or more PDU sessions 405. A PDU session represents a data path between the VMR-UE 25 and the core network of PLMN-A 30, for example, and represents a logical connection between the VMR-UE 25 and a data network (DN), such as the Internet or a private network. Examples of data networks are shown in FIG. 4, including a control-plane DN 410, a user-plane DN 420, and an application DN 430. A PDU session is generally used to carry user data and can support different types of services, such as voice, video, and data. PDU session establishment is initiated, for example, by sending a request to the core network (e.g., 5G CN). The request includes information about the type of service that the UE wants to use, and the type of traffic. Once the PDU session has been established, the VMR-UE 25 can use it to send and receive data. The 5G CN manages the resources used by the PDU session to ensure that the network is used efficiently and that the VMR-UE 25 receives the appropriate quality of service (“QoS”). As persons skilled in the art will understand, a PDU session involves various aspects that are not illustrated in FIG. 4, such as one or more data radio bearers (“DRBs”), one or more F1-U tunnels, an N3 tunnel, one or more QoS flows, and tunnel endpoint identifiers (“TEIDs”), among other aspects. Persons skilled in the art will understand such aspects of a PDU session.

In accordance with aspects of the present disclosure, the VMR-UE 25 may establish one or more PDU sessions to carry data (e.g., control plane (“C-plane”) data, user plane (“U-plane”) data, interface control messages, signaling, etc.), from the VMR-NN 23 and/or from the remote UE 10, as application layer payloads over the VMR-UE's PDU session(s) 405. The PDU session(s) 405 may also carry the VMR-UE's own user plane data. In various embodiments, separate PDU sessions 405 may carry, as application payloads, (a) VMR-NN's interface control messages, (b) one or more remote UEs' control plane/user plane data, and (c) VMR-UE's own user plane data. For example, a first PDU session may carry (a) VMR-NN's interface control messages, a second PDU session may carry (b) one or more remote UEs' control plane/user plane data, and a third PDU session may carry (c) VMR-UE's own user plane data. In various embodiments, a single PDU session may carry (a) and (b), while a separate PDU session may carry (c). In various embodiments, a single PDU session may carry all of (a), (b), and (c). In various embodiments, separate PDU sessions may carry remote UEs' control plane data and remote UEs' user plane data. Other implementations of PDU sessions for carrying various data are possible and are contemplated to be within the scope of the present disclosure.

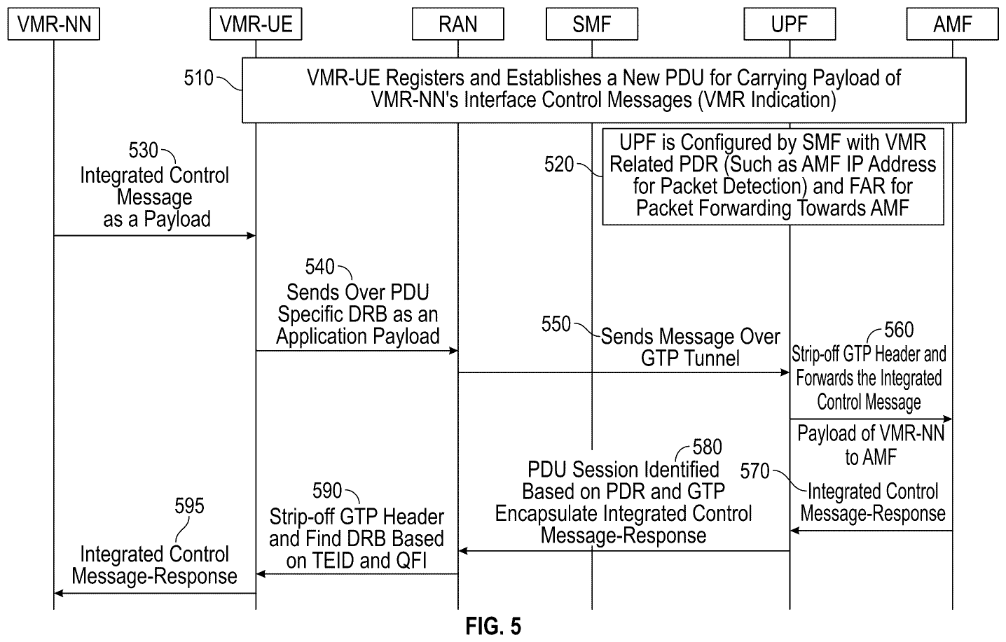

In FIG. 4, the lines and arrow denote communications connections between devices or components, which may be logical connections and/or physical connections. The connection between the VMR-NN and VMR-UE may be any type of connection, such as a logical connection or a physical connection (wired or wireless). As an example of a logical connection, the VMR-NN may be implemented as an application software in the VMR-UE. Various communications between devices and components will be described in more detail below in connection with FIG. 5 and FIG. 6.

FIG. 4 is merely illustrative, and variations are contemplated to be within the scope of the present disclosure. In embodiments, devices, components, and communications may include others not illustrated in FIG. 4. In embodiments, the devices, components, and communications may not include everything illustrated in FIG. 4. In embodiments, the devices, components, and communications may be implemented in a different arrangement than that illustrated in FIG. 4. Such and other embodiments are contemplated to be within the scope of the present disclosure.

FIG. 5 is a diagram of example signals and operations, of the system of FIG. 4, for a VMR-NN to transmit interface control messages to the wireless network and receive interface control messages from the wireless network. The following paragraphs will describe various signals and operations. It will be understood that a described signal may have associated operations and a described operation may have associated signals. Accordingly, a described signal may also involve an operation, and a described operation may also involve a signal. Additionally, FIG. 5 will describe signals between and operations performed by various systems, devices, and components, such as those shown at the top of FIG. 5, which correspond to those shown in FIG. 4. Specifically, the systems, devices, and components include a VMR-NN, a VMR-UE, a radio access network (RAN) (e.g., a gNB), a session management function (SMF) for the VMR-UE, a user plane function (UPF) for the VMR-UE, and an access and mobility management function (AMF) 32 for the VMR-UE. The systems, devices, and components are illustrative, and it is contemplated that other devices and components (such as those shown or described in connection with FIG. 1 and FIG. 2) may be involved in the signals or may perform the operations.

At operation 510, the VMR-UE registers with its core network and establishes a PDU session (e.g., 405, FIG. 4). The VMR-UE transmits, to the core network, an indication that the PDU session is for carrying interface control messages of the VMR-NN, and the core network receives the indication from the VMR-UE. Interface control messages are used by the VMR-NN for setup and VMR-NN's configuration. In various embodiments, the interface control messages of or for the VMR-NN may include one or more of the following: control plane messages, NGSetup, RAN configuration update, AMF configuration update, NG reset, error indication, AMF status indication, and/or overload indication, among other messages, which persons skilled in the art will recognize. The interface control messages of the VMR-NN may be carried over the PDU session as the VMR-UE's application payload, which is described in more detail below.

Because the VMR-UE will have its own application data, various components of the VMR-UE may need to distinguish between application data from/for the VMR-UE and application data from/for the VMR-NN. In the uplink direction, the application data from the VMR-UE will include the VMR-UE's identifier parameter value (e.g., VMR-UE's IP address), and application data from the VMR-NN will include the VMR-NN's identifier parameter value (e.g., VMR-NN's IP address). The SMF for the VMR-UE may configure an uplink (UL) QoS rule for application packet detection at the VMR-UE in such a way that the VMR-UE will use the VMR-NN's identifier parameter value (e.g., VMR-NN's IP address) to transmit the VMR-NN's application data using VMR-UE's PDU session.

In various embodiments, the UL QOS rule may be provisioned by the SMF during VMR-UE's PDU session establishment.

In various embodiments, the identifier parameter (e.g. IP address/prefix and/or frame routes) values can be obtained based on the VMR-UE's UDM's session management (SM) subscription information or based on the SMF's local configuration.

In various embodiments, the identifier parameter values can be obtained by receiving, from the VMR-UE, during the PDU session establishment, the VMR-NN's identifier parameter value (e.g., VMR-NN's IP address) and/or an identifier parameter value (e.g., IP address) for an AMF for the VMR-NN.

In various embodiments, the identifier parameter values can be obtained based on the VMR-UE's policy control function (PCF) policy providing predefined AMF's and VMR-NN's identifier parameter values (e.g., VMR-NN's IP address) in session management policy.

At operation 520, the SMF for the VMR-UE configures the UPF for the VMR-UE with packet detection rules (PDRs) for detecting VMR-related packets and with and forwarding action rules (FARs) for forwarding the VMR-related packets to the AMF for the UE. The PDR/FAR may be configured via packet forwarding control protocol (PFCP) association establishment or modification).

In various embodiments, the UPF for the VMR-UE may be configured to forward uplink packets, with the destination address (e.g., IP address) set to the AMF's address (e.g., IP address), towards the AMF for the VMR-NN.

In various embodiments, the UPF for the VMR-UE may be configured to forward downlink packets, from the VMR-NN's AMF, for which source address (e.g., IP address) is mapped to a specific PFCP session to identify PDU binding.

In various embodiments, PDR and FAR for detecting and forwarding packets from the VMR-NN may have the following parameters, which persons skilled in the art will recognize.

| PDR | FAR | Packet flow direction |
|---|---|---|
| Source interface = Access | Destination interface = | UL |
| TEID = X | N6 | |
| Destination IP = AMF IP | | |
| Source interface = N6 | Destination interface = | DL |
| Source IP = AMF IP or | access; | |
| Destination IP = VMR-gNB | Outer header creation N3 | |
| | (TEID = X); | |

At operation 530, the VMR-NN transmits, to the VMR-UE, an interface control message as application data for the VMR-UE, and the VMR-UE receives the interface control message from the VMR-NN.

At operation 540, the VMR-UE transmits, to the RAN, the interface control message as an application payload over the PDU session, and the RAN receives the interface control message/application payload from the VMR-UE. As persons skilled in the art will understand, the interface control message/application payload is transmitted in a data radio bearer (DRB), and the VMR-UE will identify the DRB for transmitting the interface control message/application payload based on QFI associated with different QoS flows.

At operation 550, the RAN transmits, to the UPF for the VMR-UE, the interface control message/application payload over a F1-U tunnel and a N3 tunnel according to general packet radio service tunneling protocol (GTP), which may be referred to herein as a GTP tunnel. As persons skilled in the art will understand, the RAN, e.g., a GNB DU, encodes the application payload with a GTP header. The UPF for the VMR-UE receives the GTP-encapsulated application payload from the RAN.

At operation 560, the UPF for the VMR-UE removes the GTP header from the GTP-encapsulated application payload and transmits, to the AMF, the application payload containing the interface control message of the VMR-NN. The AMF for the VMR-UE receives the application payload from the UPF for the VMR-NN (which may be the same as the UPF for the VMR-UE), performs operations relating to the interface control message, and provides an interface control message response. For example, if the interface control message is a NG-setup message, the AMF for the VMR-UE may provide a NG-setup-response.

At operation 570, the AMF for the VMR-UE transmits, to the UPF for the VMR-UE, the interface control message response, and the UPF for the VMR-NN receives the interface control message response.

At operation 580, UPF for the VMR-UE transmits, to the RAN, the interface control message response over the PDU session and a GTP tunnel. The UPF for the VMR-UE identifies the PDU session based on the PDR configured by the SMF for the VMR-UE and encapsulates the interface control message response in a GTP header based on FAR configured by the SMF. The RAN receives the GTP-encapsulated interface control message response from the UPF for the VMR-NN.

At operation 590, the RAN removes the GTP header from the GTP-encapsulated interface control message response and transmits, to the VMR-UE, the interface control message response over a DRB. The RAN may identify the DRB based on a tunnel endpoint identifier (TEID) and may identify a QoS flow within the DRB using a QoS flow identifier (“QFI”). Persons skilled in the art will understand how to implement TEID and QFI for a PDU session. The VMR-UE receives the interface control message response from the RAN.

At operation 595, the VMR-UE transmits, to the VMR-NN, the interface control message response, and the VMR-NN receives the interface control message response from the VMR-UE.

Accordingly, in the manner described above, a VMR-NN may be deployed without the wireless system needing to support IAB.

The signals and operations of FIG. 5 are merely illustrative, and variations are contemplated to be within the scope of the present disclosure. In embodiments, the signals and operations may include others not illustrated in FIG. 5. In embodiments, the signals and operations may not include every signal and operation illustrated in FIG. 5. In embodiments, the signals and operations may be implemented in a different order than that illustrated in FIG. 5. Such and other embodiments are contemplated to be within the scope of the present disclosure.

FIG. 6 is a diagram of example signals and operations, of the system of FIG. 4, for one or more remote UEs, which are connected to the VMR-NN, to transmit data to the wireless network (e.g., to a data network) and receive data from the wireless network. The following paragraphs will describe various signals and operations. It will be understood that a described signal may have associated operations and a described operation may have associated signals. Accordingly, a described signal may also involve an operation and a described operation may also involve a signal.

Additionally, FIG. 6 will describe signals between and operations performed by various systems, devices, and components, such as those shown at the top of FIG. 6, which correspond to those shown in FIG. 4. Specifically, the systems, devices, and components include a remote UE, a VMR-NN, a VMR-UE, a radio access network (RAN) (e.g., a gNB), an access and mobility management function (AMF), a session management function (SMF), a user plane function (UPF), a service chaining or forwarding data network (DN), and an application DN. In various embodiments, the remote UE and the VMR-UE may have different SMF, UPF, and AMF. The following paragraphs will separately refer to the network functions for remote UE and the network functions for the VMR-UE, but it will be understood that the described network functions may serve both the remote UE and the VMR-UE. For clarity, each of the SMF, UPF, and AMF, is shown in FIG. 6 by a single block. The systems, devices, and components shown at the top of FIG. 6 are illustrative, and it is contemplated that other devices and components (such as those shown or described in connection with FIG. 1 and FIG. 2) may be involved in the signals or may perform the operations.

As mentioned above, the following description will refer to a remote UE, but it is intended that any description referring to a remote UE shall be treated as though the description also referred to more than one remote UE, as well.

Before operation 610, the VMR-UE has already established a PDU session with the core network in the manner described at operation 510. Accordingly, a first PDU session exists for communicating interface control messages of the VMR-NN. As explained below, the first PDU session may also be used for the remote UE's non access stratum (NAS) signaling towards remote UE's AMF.

At operation 610, the remote UE transmits a registration request to register with its core network. The remote UE transmits the registration request to the VMR-NN, and the VMR-NN receives the registration request from the remote UE.

At operations 612-616, the operations proceed in the manner described for operations 530-595 of FIG. 5, in which an application payload is transmitted over the first PDU session to the core network and a response from the core network is received over the first PDU session. The first PDU session is established between the VMR-UE and the UPF for the VMR-UE. The UPF for the VMR-UE then, however, transmits the registration request to the AMF for the remote UE, which may be the same as or different from the AMF for the VMR-UE.

Specifically, at operation 612, the application payload includes the remote UE's registration request, and the response from the core network may be an acknowledgment that the remote UE is registered.

At operation 614, the remote UE transmits a request to establish a PDU session. The application payload includes the remote UE's request to establish a PDU session, and the response, at operation 616, includes PDU resource setup information. The PDU resource setup information may be provided by the SMF for the remote UE, which may be the same as or different from the SMF for the VMR-UE. The PDU resource setup information may include, for example, GTP TEID information, among other possible information. The PDU resource setup information enables the remote UE to establish a PDU session between the remote UE and the UPF for the remote UE and to establish a GTP tunnel between the VMR-NN and the UPF for the remote UE. However, as described below, the PDU session between the remote UE and the UPF for the remote UE operates over a second PDU session between the VMR-UE and the UPF for the VMR-UE.

At operation 618, the VMR-NN requests the VMR-UE to establish a second PDU session that is distinct from the first PDU session, and the operation is similar to operation 510 of FIG. 5. The VMR-UE establishes a second PDU session with the UPF for the VMR-UE and indicates to the core network that the PDU session is for the remote UE's data (e.g., control plane data and/or user plane data). After operation 618, the VMR-UE will have two PDU sessions. The first PDU session is indicated for the VMR-NN's interface control messages, and the second PDU session is indicated for the remote UE's data.

At operation 620, for the second PDU session, the SMF for the VMR-UE configures the UPF for the VMR-UE with packet detection rules (PDRs) for detecting the remote UE's packets and with and forwarding action rules (FARs) for forwarding the remote UE's packets. As described below, the UPF for the VMR-UE may forward the remote UE's packets to the UPF for the remote UE, towards one or more data networks.

In various embodiments, the UPF for the VMR-UE is provided with PDR with remote UE's PDU layer identifier parameter value (e.g., VMR-NN's IP address) to detect and map GTP-encapsulated packets received for N6 forwarding either to service chaining or forwarding DN or to another intermediate DN. Such DN's are able to perform destination address (e.g., IP address) based routing. The intermediate DNs may forward the packets to the UPF for the remote UE using provisioned FAR rules.

In various embodiments, the SMF for the remote UE configures the UPF for the remote UE to identify the remote UE's identifier parameter value (e.g., remote UE IP address) and/or to identify the remote UE's application DN address (e.g., DN IP address) to perform N6 forwarding.

In various embodiments, a similar approach may be applied by the remote UE's SMF and/or the VMR-UE's SMF to configure their respective UPFs to forward downlink (DL) traffic towards the remote UE using PDR and FAR parameters below, which persons skilled in the art will understand.

VMR-UE's UPF

| PDR | FAR | Packet flow direction |
|---|---|---|
| Source interface = Access | Destination interface = | UL |
| TEID = X | N6(-Towards Remote | |
| Destination IP = Remote | UE's UPF) | |
| UE's UPF IP | | |
| Source interface = N6 | Destination interface = | DL |
| Source IP = Remote UE's | access; | |
| UPF IP or | Outer header creation N3 | |
| Destination IP = VMR-gNB | (TEID = X); | |

Remote-UE's UPF

| PDR | FAR | Packet flow direction |
|---|---|---|
| Source interface = | Destination interface = | UL |
| N6(-Intermediate-DN or VMR- | N6(-Application DN) | |
| UE's UPF) | | |
| TEID = Y | | |
| Destination IP = Remote | | |
| UE's UPF IP | | |
| Source interface = N6 | Destination interface = | DL |
| Destination IP = Remote | access; | |
| UE's IP or | Outer header creation N3 | |
| Source IP = application IP | (TEID = Y); | |

The following operations 622-638 describe the transmission of an uplink application packet from the remote UE to an application DN.

At operation 622, the remote UE transmits, to the VMR-NN, an application payload of the remote UE for an application DN, and the VMR-NN receives the application payload from the remote UE. Because the remote UE transmits the application payload over its PDU session, the transmission is over a data radio bearer of the remote UE's PDU session.

At operation 624, the VMR-NN encodes the application payload with a GTP header based on information in the PDU setup information received at operation 616, thereby implementing a GTP tunnel for the remote UE's PDU session. The VMR-NN transmits, to the VMR-UE, the GTP-encapsulated application payload over a GTP tunnel, and the VMR-UE receives the GTP-encapsulated application payload from the VMR-UE.

At operation 626, the VMR-UE identifies uplink QoS rules for transmitting the GTP-encapsulated application payload over the VMR-UE's second PDU session. As persons skilled in the art will understand, the second PDU session includes QoS flows in DRBs. The uplink QoS rules apply to the QoS flows, which persons skilled in the art will understand.

At operation 628, the VMR-UE transmits, to the RAN, the GTP-encapsulated application payload as an application payload over a DRB of the VMR-UE's second PDU session, and the RAN receives the application payload from the VMR-UE.

At operation 630, the RAN encodes the GTP-encapsulated application payload (from operation 624) with a GTP header for the GTP tunnel of the VMR-UE's second PDU session. The RAN provides a twice-GTP-encapsulated application payload. The RAN transmits, to the UPF for the VMR-UE, the twice-GTP-encapsulated application payload over the GTP tunnel for the second PDU session, and the UPF for the VMR-UE receives the twice-GTP-encapsulated application payload.

At operation 632, the UPF for the VMR-UE removes the GTP header for the second PDU session from the twice-GTP-encapsulated application payload and forwards the GTP-encapsulated application payload. The UPF for the VMR-UE may forward in three ways.

In a first way, the UPF for the VMR-UE may forward the GTP-encapsulated application payload to an intermediate DN, such as a service chained or forwarding DN or an IP router. The intermediate DN may then forward the GTP-encapsulated application payload to UPF for the remote UE.

In a second way, the UPF for the VMR-UE may forward the GTP-encapsulated application payload directly to the remote UE's UPF, e.g., using normal IP forwarding over N6 where the VMR-UE's UPF send the payload on N6 interface and the remote UE's UPF receives the payload over its N6 interface.

In a third way, in case the UPF for the VMR-UE and the UPF for the remote UE are the same UPF, the UPF for the VMR-UE may forward the GTP-encapsulated application payload to a virtual internal port. An example of parameters for virtual internal port forwarding may be as follows, which persons skilled in the art will recognize.

| | | PDR and FAR (for UL packet from |
|---|---|---|
| Methods | UL/DL | Remote UE towards Application) |
| Internal | N4 rules for | A PDR containing Source Interface set to “access side”, and CN |
| Switching | UL (for | Tunnel Information set to PDU Session tunnel header (i.e. N3 |
| | VMR-UE) | GTP-U F-TEID of VMR-UE's PDU); and |
| | | A FAR containing Destination Interface set to “VMR internal”. |
| | N4 rules for | A PDR containing Source Interface set to “VMR internal”, CN |
| | DL (for | Tunnel Information set to PDU Session tunnel header (i.e. N3 |
| | Remote-UE) | GTP-U F-TEID of Remote-UE's PDU); and |
| | | A FAR containing Destination Interface set to “N6”.Outer |
| | | Header Creation indicating the N3 tunnel information, and |
| | | Destination Interface set “access side”. |

| Methods | UL/DL | PDR and FAR (for DL packet for Remote UE from Application) |
|---|---|---|
| Internal | N4 rules for | A PDR containing Source Interface set to “N6”, and destination |
| Switching | UL (for | address is Remote UE's IP address; and |
| | Remote-UE) | A FAR containing Outer Header Creation indicating the N3 tunnel |
| | | information, and Destination Interface set “VMR internal”. |
| | N4 rules for | A PDR containing Source Interface set to “VMR internal”, |
| | DL (for | and destination address is VMR-gNB IP address; and |
| | VMR-UE) | A FAR containing Outer Header Creation indicating the N3 tunnel |
| | | information, and Destination Interface set “access side”. |

The flow diagram proceeds on the assumption that the UPF for the VMR-UE forwards the GTP-encapsulated application payload to a service chaining or forwarding DN. At operation 634, the UPF for the VMR-UE transmits, to a service chaining or forwarding DN, the GTP-encapsulated application payload, and the service chaining or forwarding DN receives the GTP-encapsulated application payload from the UPF for the VMR-UE.

At operation 636, the service chaining or forwarding DN transmits, to the UPF for the remote UE, the GTP-encapsulated application payload, and the UPF for the remote UE receives the GTP-encapsulated application payload from the service chaining or forwarding DN.

At operation 638, the UPF for the remote UE removes the GTP header (provided in operation 624) from the GTP-encapsulated application payload. The UPF for the remote UE transmits, to an application DN, the application payload, and the application DN receives the application payload from the UPF for the remote UE.

The following operations 640-650 describe transmission of a downlink application packet from the application DN to the remote UE.

At operation 640, the application DN transmits, to the UPF for the remote UE, application data for the remote UE, and the UPF for the remote UE receives the application data from the application DN.

At operation 642, the UPF for the remote UE encodes the application data with a GTP header to provide a GTP-encapsulated application data. The UPF for the remote UE transmits, to the service chaining and forwarding DN, the GTP-encapsulated application data, and the service chaining and forwarding DN receives the GTP-encapsulated application data from the UPF for the remote UE.

At operation 644, the service chaining and forwarding DN transmits, to the UPF for the VMR-UE, the GTP-encapsulated application data, and the UPF for the VMR-UE receives the GTP-encapsulated application data from the service chaining and forwarding DN. The UPF for the VMR-UE adds a GTP header for the GTP tunnel for the VMR-UE's second PDU session to provide a twice-GTP-encapsulated application data.

At operation 646, UPF for the VMR-UE transmits, to the RAN, the twice-GTP-encapsulated application data over the VMR-UE's second PDU session. The UPF for the VMR-UE identifies the second PDU session based on the PDR configured by the SMF for the VMR-UE. The RAN receives the twice-GTP-encapsulated application data from the UPF for the VMR-UE.

At operation 648, the RAN removes the GTP header for the second PDU session from the twice-GTP-encapsulated application data and transmits, to the VMR-UE, the GTP-encapsulated application data over a DRB. The RAN may identify the DRB based on a tunnel endpoint identifier (TEID) and may identify a QoS flow within the DRB using a QoS flow identifier (“QFI”). The VMR-UE receives the GTP-encapsulated application data from the RAN. Then, the VMR-UE transmits, to the VMR-NN, the GTP-encapsulated application data, and the VMR-NN receives the GTP-encapsulated application data from the VMR-UE.

At operation 650, the VMR-NN removes the GTP header for the remote UE's PDU session from the GTP-encapsulated application data. The VMR-NN transmits, to the remote UE, the application data, and the remote UE receives the application data.

Accordingly, in the manner described above, application data to or from the remote UE may be communicated in a VMR system without supporting IAB.

The signals and operations of FIG. 6 are merely illustrative, and variations are contemplated to be within the scope of the present disclosure. In embodiments, the signals and operations may include others not illustrated in FIG. 6. In embodiments, the signals and operations may not include every signal and operation illustrated in FIG. 6. In embodiments, the signals and operations may be implemented in a different order than that illustrated in FIG. 6. Such and other embodiments are contemplated to be within the scope of the present disclosure.

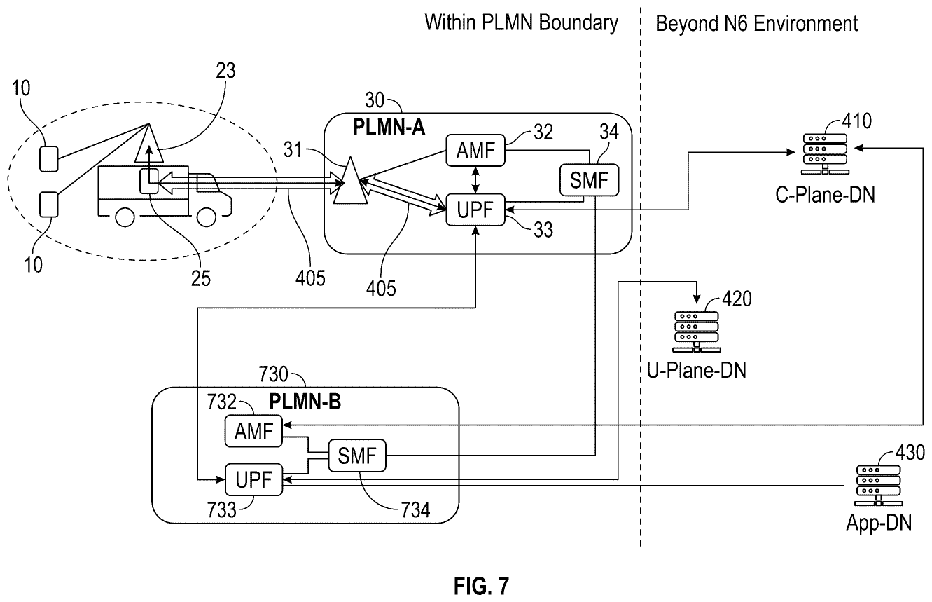

FIGS. 4-6 show examples where the VMR-UE, the VMR-NN, and the remote UE are all subscribed with the same PLMN, e.g., PLMN-A. FIG. 7 shows an example where the VMR-NN and/or the remote UE are subscribed with a different PLMN (e.g., PLMN-B). In FIG. 7, PLMN-B 730 includes an AMF 732, a UPF 733, and a SMF 734. Signals and operations for the example of FIG. 7 are similar to the signals and operations of FIG. 5, in which the UPF for the VMR-UE forwards data to another UPF. In case PLMN-B is VMR-NN's H-PLMN, interface control messages for VMR-NN would be routed through the UPF in PLMN-B to the AMF in PLMN-B. In case PLMN-B is the remote UE's H-PLMN, application data of the remote UE would be routed through the UPF in PLMN-B to various data networks. The PLMN-A and PLMN-B UPF to UPF packet forwarding can be based on public IP routing, based on forwarding by an intermediate DN which is common to both PLMN-A and PLMN-B, and/or based on a business agreement to avail point-to-point (PtP) based packet forwarding. In such cases, where the operator of PLMN-B wishes to serve the remote UE in PLMN-B, then the SMF and UDM in H-PLMN of VMR-UE (i.e., PLMN-A) would be made aware of that arrangement through local configuration and/or session management (SM) subscription.

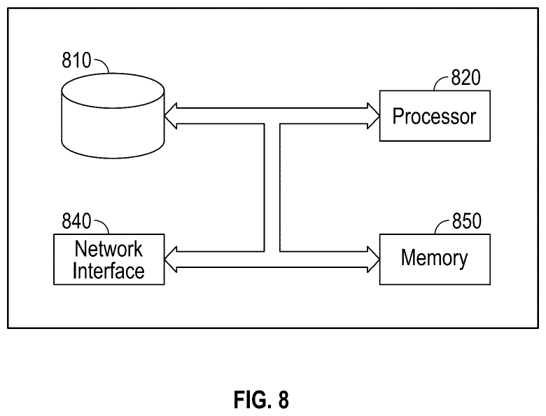

Referring now to FIG. 8, there is shown a block diagram of example components of a UE or a network apparatus. The apparatus includes an electronic storage 810, a processor 820, a memory 850, and a network interface 840. The various components may be communicatively coupled with each other. The processor 820 may be and may include any type of processor, such as a single-core central processing unit (CPU), a multi-core CPU, a microprocessor, a digital signal processor (DSP), a System-on-Chip (SoC), or any other type of processor. The memory 850 may be a volatile type of memory, e.g., RAM, or a non-volatile type of memory, e.g., NAND flash memory. The memory 850 includes processor-readable instructions that are executable by the processor 820 to cause the apparatus to perform various operations, including those mentioned herein, such as the operations of FIGS. 5 and 6.

The electronic storage 810 may be and include any type of electronic storage used for storing data, such as hard disk drive, solid state drive, and/or optical disc, among other types of electronic storage. The electronic storage 810 stores processor-readable instructions for causing the apparatus to perform its operations and stores data associated with such operations, such as storing data relating to 5G NR standards, among other data. The network interface 840 may implement wireless networking technologies such as 5G NR and/or other wireless networking technologies.

The components shown in FIG. 8 are merely examples, and persons skilled in the art will understand that an apparatus includes other components not illustrated and may include multiples of any of the illustrated components. Such and other embodiments are contemplated to be within the scope of the present disclosure.

Further embodiments of the present disclosure include the following examples.

Example 1.1. A user equipment comprising:
means for establishing, by a vehicle-mounted relay user equipment (VMR-UE), a protocol data unit (PDU) session with a core network with which the VMR-UE is subscribed; and
means for transmitting, to the core network, an indication that the PDU session is for at least one of the following:
   interface control messages of a vehicle-mounted relay network node (VMR-NN) that is mounted with the VMR-UE in a vehicle,
   user plane (UP) traffic of at least one second UE connected to the VMR-NN, or
   control plane (CP) traffic of the at least one second UE connected to the VMR-NN.

Example 1.2. The user equipment of Example 1.1, wherein the means for transmitting the indication comprises means for transmitting the indication that the PDU session is for the interface control messages of the VMR-NN.

Example 1.3. The user equipment of Example 1.2, further comprising:
means for receiving, from the VMR-NN, an interface control message; and
means for transmitting, over the PDU session, the interface control message as an application payload of the VMR-UE.

Example 1.4. The user equipment of Example 1.3, wherein the means for transmitting the interface control message comprises means for transmitting the interface control message using an identifier parameter of the VMR-NN.

Example 1.5. The user equipment of any of Example 1.1-Example 1.4, wherein the establishing the PDU session with the core network comprises:
means for receiving, from a session management function (SMF) of the core network, an uplink (UL) quality of service (QOS) rule configured for detecting the interface control messages of the VMR-NN.

Example 1.6. The user equipment of any of Example 1.1-Example 1.5, further comprising:
means for receiving, by the VMR-UE, an interface control message response from the core network over the PDU session; and
means for transmitting, by the VMR-UE, to the VMR-NN, the interface control message response.

Example 1.7. The user equipment of Example 1.2, further comprising:
means for receiving, by the VMR-UE, from the VMR-NN, at least one registration request for the at least one second UE to register with an access and mobility management function (AMF); and
means for transmitting, by the VMR-UE, over the PDU session, the at least one registration request for the at least one second UE.

Example 1.8. The user equipment of Example 1.7, further comprising:

means for receiving, by the VMR-UE, from the core network over the PDU session, PDU session resource setup information provided by a session management function (SMF), wherein the PDU session resource setup information is configured to enable the at least one second UE to establish a PDU session with a user plane function (UPF) for the at least one second UE.

Example 1.9. The user equipment of Example 1.7 or Example 1.8, further comprising:
means for receiving, by the VMR-UE, from the VMR-NN, an instruction to establish a second PDU session with the core network for at least one of the UP traffic of the at least one second UE or the CP traffic of the at least one second UE;
means for establishing the second PDU session with the core network, the second PDU session being distinct from the PDU session for the interface control messages of the VMR-NN; and
means for transmitting, to the core network, an indication that the second PDU session is for at least one of the UP traffic or the CP traffic of the at least one second UE.

Example 1.10. The user equipment of Example 1.9, further comprising:
means for receiving, from the VMR-NN, at least one of a UP data of the at least one second UE or a CP data of the at least one second UE; and
means for transmitting, to the core network over the second PDU session, the at least one of the UP data of the at least one second UE or the CP data of the at least one second UE.

Example 1.11. The user equipment of Example 1.10,
wherein the receiving the at least one of the UP data of the at least one second UE or the CP data of the at least one second UE comprises receiving a general packet radio service tunneling protocol (GTP)-encapsulated application payload comprising the at least one of the UP data of the at least one second UE or the CP data of the at least one second UE, and
wherein the transmitting the at least one of the UP data or the CP data of the at least one second UE comprises transmitting, to the core network over the second PDU session, the GTP-encapsulated application payload comprising the at least one of the UP data or the CP data of the at least one second UE.

Example 1.12. The user equipment of any of Example 1.9-Example 1.11, further comprising:
means for receiving, by the VMR-UE, from the core network over the second PDU session, application data for the at least one second UE; and
means for transmitting, to the VMR-NN, the application data for the at least one second UE.

Example 1.13. The user equipment of Example 1.12,
wherein the receiving the application data for the at least one second UE comprises receiving a general packet radio service tunneling protocol (GTP)-encapsulated application payload comprising the application data for the at least one second UE, and
wherein the transmitting the application data for the at least one second UE comprises transmitting the GTP-encapsulated application payload comprising the application data for the at least one second UE.

Example 2.1. An apparatus comprising:
means for establishing, by at least one component of a core network, a protocol data unit (PDU) session with a vehicle-mounted relay user equipment (VMR-UE) which is subscribed with the core network; and
means for receiving, from the VMR-UE, an indication that the PDU session is for at least one of the following:
   interface control messages of a vehicle-mounted relay network node (VMR-NN) that is mounted with the VMR-UE in a vehicle,
   user plane (UP) traffic of at least one second UE connected to the VMR-NN; or
   control plane (CP) traffic of the at least one second UE connected to the VMR-NN.

Example 2.2. The apparatus of Example 2.1, wherein the means for receiving the indication comprises means for receiving the indication that the PDU session is for the interface control messages of the VMR-NN.

Example 2.3. The apparatus of Example 2.2, further comprising:

means for receiving, from the VMR-UE, over the PDU session, an application payload of the VMR-UE, the application payload of the VMR-UE comprising an interface control message of the VMR-NN.

Example 2.4. The apparatus of claim 2.3, wherein the interface control message of the VMR-NN, received from the VMR-UE, comprises an identifier parameter of the VMR-NN

Example 2.5. The apparatus of any of Example 2.1-Example 2.4, further comprising:
means for configuring, by a session management function (SMF) of the at least one component of the core network, an uplink (UL) quality of service (QOS) rule configured for detecting the interface control messages of the VMR-NN; and
means for transmitting, to the VMR-UE, the UL QOS rule for use by the VMR-UE for detecting the interface control messages of the VMR-NN.

Example 2.6. The apparatus of Example 2.5, wherein the configuring of the UL QoS rule is based on at least one of the following:
an identifier parameter of the VMR-NN, or
an identifier parameter of an access and mobility management function (AMF) for the VMR-NN.

Example 2.7. The apparatus of Example 2.6, further comprising:
means for obtaining at least one of the following:
   the identifier parameter of the VMR-NN, or
   the identifier parameter of the AMF for the VMR-NN,
from at least one of the following:
   a unified data management (UDM) session management (SM) subscription for the VMR-UE,
   a local configuration of the SMF, or
   a policy control function (PCF) policy for the VMR-UE.

Example 2.8. The apparatus of Example 2.6, further comprising:
means for receiving, from the VMR-UE, during the establishing the PDU session, at least one of the following:
   the identifier parameter of the VMR-NN, or
   the identifier parameter of the AMF for the VMR-NN.

Example 2.9. The apparatus of any of Example 2.1-Example 2.8, further comprising:
means for configuring a user plane function (UPF), by a session management function (SMF) of the at least one component of the core network, with a packet detection rule (PDR) and forwarding action rule (FAR) configured to detect and forward a packet to the AMF of the VMR-NN,
wherein the packet comprises a destination address set to an address of an access and mobility management function (AMF) for the VMR-NN.

Example 2.10. The apparatus of any of Example 2.1-Example 2.9, further comprising:

means for configuring a user plane function (UPF), by the session management function (SMF) of the at least one component of the core network, with packet detection rule (PDR) and forwarding action rule (FAR) configured to detect and forward a packet comprising a source address that is set to the address of the AMF of the VMR-NN and that is mapped to a packet forwarding control protocol (PFCP) session.

Example 2.11. The apparatus of any of Example 2.1-Example 2.10, further comprising:
means for receiving, by a user plane function (UPF) of the at least one component of the core network, a message from an access and mobility management function (AMF) for the VMR-NN; and
means for generating, based on the message from the AMF for the VMR-NN, a general packet radio service tunneling protocol (GTP)-encapsulated message.

Example 2.12. The apparatus of Example 2.2, further comprising:
means for receiving, from the VMR-UE, over the PDU session, at least one registration request for the at least one second UE to register with an access and mobility management function (AMF) for the at least one second UE.

Example 2.13. The apparatus of Example 2.12, further comprising:
means for selecting, by the AMF for the at least one second UE, a session management function (SMF) for the at least one second UE.

Example 2.14. The apparatus of Example 2.13, further comprising:
means for transmitting, by the SMF for the at least one second UE, over the PDU session, PDU session resource setup information configured to enable the at least one second UE and a user plane function (UPF) for the at least one second UE to establish a PDU session.

Example 2.15. The apparatus of Example 2.2, further comprising:
means for establishing a second PDU session with the VMR-UE, the second PDU session being distinct from the PDU session for the interface control messages of the VMR-NN; and
means for receiving, from the VMR-UE, an indication that the second PDU session is for at least one of the UP traffic of the at least one second UE or the CP traffic of the at least one second UE.

Example 2.16. The apparatus of Example 2.15, further comprising:
means for configuring a user plane function (UPF) for the VMR-UE, by a session management function (SMF) for the VMR-UE, with at least one of the following:
   a packet detection rule (PDR) and forwarding action rule (FAR) configured to detect and forward an uplink packet comprising a destination IP address set to an IP address of a UPF for the at least one second UE, or
   a PDR and FAR configured to detect and forward a downlink packet comprising a source address set to an address of the UPF for the at least one second UE.

Example 2.17. The apparatus of Example 2.16, wherein the PDR and FAR are configured to detect and forward the packet to an intermediate data network (DN), the intermediate DN being a service chaining or forwarding DN configured to forward the packet to the UPF for the at least one second UE.

Example 2.18. The apparatus of any of Example 2.15-Example 2.17, further comprising:
means for configuring the UPF for the at least one second UE, by an SMF for the at least one second UE, with at least one of the following:
   a packet detection rule (PDR) and forwarding action rule (FAR) configured to detect and forward an uplink packet comprising a destination address set to an address of the UPF for the at least one second UE, or
   a PDR and FAR configured to detect and forward a downlink packet comprising a source address set to an address of an application server.

Example 2.19. The apparatus of Example 2.15, further comprising:
means for receiving, by a user plane function (UPF) for the VMR-UE, from the VMR-UE, over the second PDU session, at least one of a UP data or a CP data of the at least one second UE; and
means for forwarding, by the UPF for the VMR-UE, at least one of the UP data of the at least one second UE or the CP data of the at least one second UE.

Example 2.20. The apparatus of Example 2.19, wherein the forwarding the at least one of the UP data or the CP data of the at least one second UE comprises:
means for forwarding the at least one of the UP data or the CP data, by the VMR-UE, to an intermediate data network (DN), the intermediate DN being a service chaining or forwarding DN configured to forward to the at least one of the UP data of the at least one second UE or the CP data to a UPF for the at least one second UE.

Example 2.21. The apparatus of Example 2.19, wherein the means for forwarding the at least one of the UP data of the at least one second UE or the CP data of the at least one second UE comprises:
means for forwarding the at least one of the UP data or the CP data, by the UPF for the VMR-UE, to a UPF for the at least one second UE, using IP forwarding over N6 interface.

Example 2.22. The apparatus of Example 2.19, wherein the UPF for the VMR-UE is also the UPF for the at least one second UE,
wherein the means for forwarding the at least one of the UP data or the CP data of the at least one second UE comprises means for forwarding the at least one of the UP data or the CP data, by the UPF for the VMR-UE, to a virtual internal port before N6 forwarding.

Example 2.23. The apparatus of any of Example 2.15-Example 2.22, further comprising:
means for receiving, by the UPF for the VMR-UE, application data for the at least one second UE; and
means for transmitting, to the VMR-UE, over the second PDU session, the application data for the at least one second UE.

The embodiments and aspects disclosed herein are examples of the present disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different aspects in accordance with this present disclosure. The phrase “a plurality of” may refer to two or more.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

While aspects of the present disclosure have been shown in the drawings, it is not intended that the present disclosure be limited thereto, as it is intended that the present disclosure be as broad in scope as the art will allow and that the specification be read likewise. Therefore, the above description should not be construed as limiting, but merely as exemplifications of particular aspects. Those skilled in the art will envision other modifications within the scope and spirit of the claims appended hereto.

We claim:

1. A vehicle-mounted relay user equipment (VMR-UE) comprising:
at least one processor; and
at least one memory storing instructions which, when executed by the at least one processor, cause the VMR-UE at least to perform:
establishing a protocol data unit (PDU) session with a core network with which the VMR-UE is subscribed; and
transmitting, to the core network, an indication that the PDU session is for at least one of the following:
interface control messages of a vehicle-mounted relay network node (VMR-NN) that is mounted with the VMR-UE in a vehicle;
user plane (UP) traffic of at least one second UE connected to the VMR-NN; or
control plane (CP) traffic of the at least one second UE connected to the VMR-NN.

2. The VMR-UE according to claim 1,
wherein the transmitting the indication comprises transmitting the indication that the PDU session is for the interface control messages of the VMR-NN; and
wherein the instructions, when executed by the at least one processor, further cause the VMR-UE at least to perform:
receiving, from the VMR-NN, an interface control message; and
transmitting, over the PDU session, the interface control message as an application payload of the VMR-UE.

3. The VMR-UE according to claim 2, wherein the transmitting the interface control message comprises transmitting the interface control message using an identifier parameter of the VMR-NN.

4. The VMR-UE according to claim 1, wherein the establishing the PDU session with the core network comprises:
receiving, from a session management function (SMF) of the core network, an uplink (UL) quality of service (QOS) rule configured for detecting the interface control messages of the VMR-NN.

5. The VMR-UE according to claim 1, wherein the instructions, when executed by the at least one processor, further cause the VMR-UE at least to perform:
receiving, by the VMR-UE, an interface control message response from the core network over the PDU session; and
transmitting, by the VMR-UE, to the VMR-NN, the interface control message response.

6. The VMR-UE according to claim 2, wherein the instructions, when executed by the at least one processor, further cause the VMR-UE at least to perform:
receiving, by the VMR-UE, from the VMR-NN, at least one registration request for the at least one second UE to register with an access and mobility management function (AMF); and
transmitting, by the VMR-UE, over the PDU session, the at least one registration request for the at least one second UE.

7. The VMR-UE according to claim 6, wherein the instructions, when executed by the at least one processor, further cause the VMR-UE at least to perform:
receiving, by the VMR-UE, from the core network over the PDU session, PDU session resource setup information provided by a session management function (SMF), wherein the PDU session resource setup information is configured to enable the at least one second UE to establish a PDU session with a user plane function (UPF) for the at least one second UE.

8. The VMR-UE according to claim 6, wherein the instructions, when executed by the at least one processor, further cause the VMR-UE at least to perform:
receiving, by the VMR-UE, from the VMR-NN, an instruction to establish a second PDU session with the core network for at least one of the UP traffic of the at least one second UE or the CP traffic of the at least one second UE;
establishing the second PDU session with the core network, the second PDU session being distinct from the PDU session for the interface control messages of the VMR-NN; and
transmitting, to the core network, an indication that the second PDU session is for at least one of the UP traffic or the CP traffic of the at least one second UE.

9. The VMR-UE according to claim 8, wherein the instructions, when executed by the at least one processor, further cause the VMR-UE at least to perform:
receiving, from the VMR-NN, at least one of a UP data of the at least one second UE or a CP data of the at least one second UE; and
transmitting, to the core network over the second PDU session, the at least one of the UP data of the at least one second UE or the CP data of the at least one second UE.

10. The VMR-UE according to claim 9,
wherein the receiving the at least one of the UP data of the at least one second UE or the CP data of the at least one second UE comprises receiving a general packet radio service tunneling protocol (GTP)-encapsulated application payload comprising the at least one of the UP data of the at least one second UE or the CP data of the at least one second UE, and
wherein the transmitting the at least one of the UP data or the CP data of the at least one second UE comprises transmitting, to the core network over the second PDU session, the GTP-encapsulated application payload comprising the at least one of the UP data or the CP data of the at least one second UE.

11. The VMR-UE according to claim 8, wherein the instructions, when executed by the at least one processor, further cause the VMR-UE at least to perform:
receiving, by the VMR-UE, from the core network over the second PDU session, application data for the at least one second UE; and
transmitting, to the VMR-NN, the application data for the at least one second UE.

12. The VMR-UE according to claim 11,
wherein the receiving the application data for the at least one second UE comprises receiving a general packet radio service tunneling protocol (GTP)-encapsulated application payload comprising the application data for the at least one second UE, and
wherein the transmitting the application data for the at least one second UE comprises transmitting the GTP-encapsulated application payload comprising the application data for the at least one second UE.

13. A method comprising:
establishing, by a vehicle-mounted relay user equipment (VMR-UE), a protocol data unit (PDU) session with a core network with which the VMR-UE is subscribed; and
transmitting, to the core network, an indication that the PDU session is for at least one of the following:
interface control messages of a vehicle-mounted relay network node (VMR-NN) that is mounted with the VMR-UE in a vehicle;
user plane (UP) traffic of at least one second UE connected to the VMR-NN; or
control plane (CP) traffic of the at least one second UE connected to the VMR-NN.

14. The method according to claim 13,
wherein the transmitting the indication comprises transmitting the indication that the PDU session is for the interface control messages of the VMR-NN, the method further comprising:
receiving, from the VMR-NN, an interface control message; and
transmitting, over the PDU session, the interface control message as an application payload of the VMR-UE.

15. The method according to claim 14, wherein the transmitting the interface control message comprises transmitting the interface control message using an identifier parameter of the VMR-NN.

16. The method according to claim 13, wherein the establishing the PDU session with the core network comprises:
receiving, from a session management function (SMF) of the core network, an uplink (UL) quality of service (QOS) rule configured for detecting the interface control messages of the VMR-NN.

17. The method according to claim 13, further comprising:
receiving, by the VMR-UE, an interface control message response from the core network over the PDU session; and
transmitting, by the VMR-UE, to the VMR-NN, the interface control message response.

18. The method according to claim 14, further comprising:
receiving, by the VMR-UE, from the VMR-NN, at least one registration request for the at least one second UE to register with an access and mobility management function (AMF); and
transmitting, by the VMR-UE, over the PDU session, the at least one registration request for the at least one second UE.

19. The method according to claim 18, further comprising:
receiving, by the VMR-UE, from the core network over the PDU session, PDU session resource setup information provided by a session management function (SMF), wherein the PDU session resource setup information is configured to enable the at least one second UE to establish a PDU session with a user plane function (UPF) for the at least one second UE.

20. The method according to claim 18, further comprising:
receiving, by the VMR-UE, from the VMR-NN, an instruction to establish a second PDU session with the core network for at least one of the UP traffic of the at least one second UE or the CP traffic of the at least one second UE;
establishing the second PDU session with the core network, the second PDU session being distinct from the PDU session for the interface control messages of the VMR-NN; and
transmitting, to the core network, an indication that the second PDU session is for at least one of the UP traffic or the CP traffic of the at least one second UE.
